(19) United States
(12) Patent Application Publication
(10) Pub. No.: US 2003/0041953 A1
(43) Pub. Date: Mar. 6, 2003

(54) Method of making a bonded nonwoven web

(75) Inventors: Gregory W. Farell, Hendersonville, TN (US); Jay Darrell Gillespie, Simpsonville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BBA Nonwovens Simpsonville, Inc., Simpsonville, SC (US)

(21) Appl. No.: 09/943,789

(22) Filed: Aug. 31, 2001

(51) Int. Cl. D04H 3/08; B32B 31/04

(52) U.S. Cl. 156/181; 156/290; 156/441; 156/555

(57) ABSTRACT

An apparatus for producing a thermally bonded nonwoven web and a process for producing such a web wherein there is provided a patterned embossing roll mounted for contacting the nonwoven web. The patterned embossing roll has an outer surface including a multiplicity of individual raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of said roll core and overlying at least said depressions, and a fluoropolymer surface coating adhered to said tie coat.

### FIELD OF THE INVENTION

This invention relates to nonwoven webs and, in particular, to the manufacture of point bonded nonwoven webs.

### BACKGROUND OF THE INVENTION

Bonded nonwoven webs are widely used and well known. Such materials have been incorporated into various products, such as disposable diapers, feminine hygiene products, medical gowns and drapes, protective garments, and disposable wipes. One widely used method for bonding involves passing a web of fibers through a heated calender nip defined by a cooperating pair of rolls. The pair of calender rolls typically includes a smooth anvil roll and a patterned embossing roll. The patterned roll is formed of metal, and its outer surface has been engraved to produce a multiplicity of individual raised lands that are spaced apart from one another by intervening depressions so that the lands of the embossed roll and the outer surface of the anvil roll form a plurality of discrete areas where the nonwoven material is compressed and thermally fused together to form point bond sites in the nonwoven fabric.

This calender bonding method has been used successfully for many years in the manufacture of nonwoven webs from conventional thermoplastic polymers such as polypropylene. More recently, with the development of more advanced designs for disposable diapers, protective garments and the like, specialized nonwovens have been engineered for use in such products. For nonwovens which are intended to come into contact with the skin of the wearer, such as the topsheet component of a disposable diaper, for example, the webs have been engineered to provide softness and comfort to the wearer. Various approaches have been taken to provide the desired level of softness. For example, according to Winebarger U.S. Pat. No. 5,057,357 the nonwoven web is thermally bonded by passing it through two successively arranged calender nips configured to provide a particular pattern of bond points that maintains softness in the bonded nonwoven. It has also been recognized that the polymers used for producing the fibers of the nonwoven web can influence the softness of the nonwoven fabric. Fowells U.S. Pat. No. 4,644,045 teaches that a spunbond nonwoven web having excellent softness can be made from fibers of linear low density polyethylene. Gessner U.S. Pat. No. 5,108,827 describes the production of nonwoven webs from multiconstituent fibers which can contain lower melting “softer” polymer constituents such as polyethylene. Nonwoven fabrics have also been produced from bicomponent fibers which include a higher melting polymer component, such as polypropylene, and a lower melting polymer component such as polyethylene.

A significant problem, however, is encountered when producing a point bonded nonwoven web with fibers containing a lower melting “softer” polymer such as polyethylene. Webs made from fibers of lower melting polymer materials, e.g. those that melt below about 140° C., are very difficult to bond because the temperature at which the thermoplastic fibers become sufficiently tacky or sticky to bond is very close to the melting temperature of the polymer. For such webs, there is a very narrow “window” of temperature, time and pressure conditions where acceptable bonding occurs. At the high speeds required for commercial production of nonwovens, it is extremely difficult to maintain the calender conditions within the zone required for acceptable bonding. Underbonding results in a web with poor abrasion resistance, evidenced by fuzz or fly-away filaments, and poor strength properties. Overbonding can also result in poor strength properties, as well as an undesirable loss of softness. A further significant problem occurs when the fibers melt and stick to the calender rolls, and then begin to wrap around the rolls of the calender stack. These calender stack wraps cause unwanted machine down time and wasted material. Such calender wraps often are initiated when fibers stick to the recessed depressions between the raised land points.

### SUMMARY OF THE INVENTION

The present invention overcomes the aforementioned problems and provides dramatic improvements in the ability to produce bonded nonwoven webs. It is especially useful and advantageous in addressing the aforementioned problem of bonding fibers or filaments containing lower melting polymer materials, such as those that melt below about 140° C. However, benefits arising from present invention are also realized in bonding nonwoven webs made from various other fiber-forming thermoplastic polymers.

According to one embodiment of the present invention, a nonwoven web is formed from thermoplastic fibers or filaments and the web is contacted with a patterned embossing roll having an outer surface including a multiplicity of individual raised calender lands which are spaced apart from one another by intervening depressions, wherein at least the depressions are covered by a surface coating of a fluoropolymer. Energy is transferred to the nonwoven web to cause the fibers or filaments thereof to fuse and form point bond sites in discrete areas where the web is contacted by the raised calender lands. Preferably, the raised calender lands form from 4 to 40 percent of the surface area of the embossing roll. More preferably, the raised calender lands are present at a concentration of 40 to 500 lands per square inch.

In one embodiment of the invention, the step of contacting the nonwoven web with a patterned embossing roll is carried out by directing the nonwoven web through a calender nip formed between a smooth, hard-surfaced anvil roll and the patterned embossing roll. In another embodiment, the patterned embossing roll is used in combination with an ultrasonic horn to ultrasonically bond the fabric in discrete zones.

Rolls having a surface with a release coating have been used in a number of industrial applications, such as in copying machines, in the manufacture of coated paper, and in coating and printing applications. However, these applications typically employ smooth-surfaced rolls. The rolls used in the nonwovens industry for producing a bonded nonwoven fabric have a patterned surface and have conventionally been produced by engraving or machining the metal surface of a cylindrical roll to form a pattern of discrete raised land areas surrounded by intervening depressions. Applicants have discovered that by providing a release coating, such as a fluoropolymer coating, in the depressions of such a patterned roll, significant improvements are achieved in the bonding of a nonwoven fabric. While the coating can also be applied to the raised lands of the roll, the primary benefits are achieved by having the coating present in the depressions. Surprisingly, the presence of the coating allows the nonwoven fabric to be heated to a higher temperature, producing stronger bonds and improved abrasion resistance, and the incidence of unwanted calender stack wraps is reduced.

The present invention is especially useful and advantageous in bonding a nonwoven fabric containing fibers or filaments of a lower-melting polymer, e.g. which melts below 140° C., and typically has a very narrow bonding window of acceptable bonding conditions. According to one aspect of the present invention a calender nip is formed between a smooth, hard-surfaced anvil roll and a cooperating patterned embossing roll, the patterned embossing roll including a metallic cylindrical roll core having an outer surface with a multiplicity of raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of the roll core and overlying at least the depressions, and a fluoropolymer surface coating adhered to the tie coat. The cooperating rolls are rotated in opposite directions and the calender nip is maintained at a temperature of from 90 to 160 degrees C and at a pressure of 50 to 1500 pounds per linear inch when used with the lower melting polymer materials. The nonwoven web is directed through the calender nip and the thermoplastic fibers or filaments thereof are thermally bonded in discrete areas corresponding to the raised calender lands.

According to one embodiment, the nonwoven web comprises fibers from at least two different polymers arranged as distinct phases in the cross-section of the fiber. In particular, the fibers can be formed as a bicomponent structure, such as a sheath-core structure comprising a sheath of a polymer which melts below 140° C. and a core of a polymer which melts at a higher temperature. Alternatively, the fibers can be formed from a highly dispersed blend of at least two different immiscible thermoplastic polymers comprising a dominant continuous phase polymer having a higher melting point in which is dispersed a discontinuous phase of a lower melting point polymer that melts below 140° C., and wherein the discontinuous phase polymer occupies at least a portion of the surface of the filaments.

Advantageously, the present invention can be operated at commercially acceptable processing speeds without suffering from stack wraps or other processing problems that plague conventional machines. Furthermore, the nonwoven webs produced according to the present invention have enhanced abrasion resistance and strength, a softer hand, and an aesthetically pleasing appearance.

The present invention also provides an apparatus for producing a thermally bonded nonwoven web which comprises means for forming thermoplastic fibers or filaments into a nonwoven web and a patterned embossing roll mounted for contacting the nonwoven web. The patterned embossing roll has an outer surface including a multiplicity of individual raised calender lands which are spaced apart from one another by intervening depressions, wherein at least the depressions are covered by a surface coating of a fluoropolymer. Means is provided cooperating with the roll for transferring energy to the nonwoven web to cause the fibers or filaments thereof to fuse and form point bond sites in discrete areas where the web is contacted by the raised calender lands.

In a more specific embodiment, the apparatus includes a smooth, hard-surfaced anvil roll and a cooperating patterned embossing roll forming a calender nip. The patterned embossing roll includes a metallic cylindrical roll core having an outer surface with a multiplicity of raised calender lands which are spaced apart from one another by intervening depressions, the raised calender lands being present at a concentration of 40 to 500 lands per square inch and forming from 4 to 40 percent of the surface area of the embossing roll. The roll has a hard tie coating adhered to the surface of the roll core and overlying at least the depressions, and a fluoropolymer surface coating adhered to the tie coat. Means is provided for rotating the anvil roll and the embossing roll in opposite directions, and means is provided for maintaining the calender nip at a temperature of from 90 to 250 degrees C and at a pressure of 50 to 1500 pounds per linear inch. The nonwoven web is through the calender nip and the thermoplastic fibers or filaments thereof are thermally bonded in discrete areas corresponding to the raised calender lands.

### BRIEF DESCRIPTION OF THE DRAWINGS

Having thus described the invention in general terms, reference will now be made to the accompanying drawings, which are not necessarily drawn to scale, and wherein:

FIG. 1 is a schematic side view of an apparatus for producing a thermally bonded nonwoven web according to one embodiment of the present invention;

FIGS. 2A and 2B show cross sectional views of two types of fibers used in forming nonwoven webs according to the present invention;

FIG. 3 is a perspective side view of a pair of calender rolls and a portion of a nonwoven web according to one embodiment of the present invention;

FIG. 4 is a greatly enlarged perspective view of a portion of one of the calender rolls shown in FIG. 3;

FIG. 5 is a greatly enlarged cross sectional view of a portion the a calender roll; and

FIG. 6 is a perspective side view of a calender roll having a plasma coating of a fluoropolymer applied thereto.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is directed to an apparatus and method for bonding a nonwoven web with a geometrically repeating pattern of bonded regions. The bonded regions are surrounded by unbonded regions so that a recognizable pattern is created. The individual bonded regions preferably form from 4 to 40 percent of the surface area of the fabric and may be present in concentrations of about 40 to 500 zones per square inch, more desirably about 100 to 300 per square inch, according to one embodiment of the present invention. In the bonded regions, the fibers or filaments of the nonwoven web soften and fuse together. The bonds created by the bonding zones imparts useful qualities to the fabric, such as web strength, surface abrasion resistance, and dimensional stability. Because the fibers or filaments at the bond sites can be heated to a higher temperature without sticking to the roll, a better and more complete fusion bond can be formed. The distinctly identifiable bond patterns can also be used as identification marks, such as to identify fabric characteristics or source of origin, and for alignment or demarcation points to assist in the assembly or production of textile products.

The present invention is applicable to thermally bonded nonwoven webs produced by various methods of manufacture commonly used in the nonwovens industry, including carding, air-laying, wet-laying, melt blowing, and spunbonding, or combinations of these methods. As is well known, carded, air-laid, and wet-laid webs are formed from fibers of discrete length, i.e. staple fibers. Spunbond webs are formed from fibers of substantially continuous length, i.e. continuous filaments, which are randomly arranged to form a web.

The fibers of the nonwoven webs are formed from one or more thermoplastic polymers that are capable of forming fusion bonds by application of pressure and heat or ultrasonic energy. Examples of such polymers include polyolefins such as polypropylene and polyethylene, polyesters such as polyethylene terephthalate, nylons such as nylon 6 and nylon 66, and combinations or blends of such polymers. The fibers or filaments may be formed entirely from a single polymer or from two or more polymers, which may form separate polymer phases. The present invention is especially advantageous when used for bonding fibers which are difficult to bond by conventional bonding methods, such as lower-melting polymers that melt below about 140° C. Examples of such lower-melting polymers include polyethylene (high density polyethylene or HDPE, low density polyethylene or LDPE, and linear low density polyethylene or LLDPE). For purposes of the present invention, the melting point can be determined by differential scanning calorimetry (DSC). A method for measuring melting point by DSC is taught by Perkin Elmer of Norwalk Conn. in their publication DSC 7 Differential Scanning Calorimeter 7 Series Thermal Analysis System.

The present invention is also useful with low crystallinity polymers that exhibit low softening points, such as certain polypropylene copolymers, ethylene vinyl acetate (EVA) and a variety of amorphous materials that are used as adhesives. The present invention is particularly applicable to fibers which include a lower melting polymer component that melts below 140° C. and one or more higher melting polymer components. The polymer components are arranged as distinct phases in the cross-section of the fiber to form multiconstituent or multicomponent fibers. For example, the fibers can be multiconstituent fibers, as described for example in Gessner U.S. Pat. No. 5,107,827 where the lower-melting component is present as a discontinuous dispersed phase in a continuous phase of a polymer component that melts at a higher temperature. Alternatively, the polymer components can include a primary continuous phase of a lower-melting polymer such as polyethylene in which is dispersed one or more higher melting polymer components. In another embodiment, the fibers can be multicomponent fibers, wherein the polymer components are disposed in specific locations within the fiber cross-section and extend continuously along the fiber length. A particularly preferred form of multicomponent fiber for use in the present invention is a sheath-core bicomponent fiber wherein the higher-melting polymer component is present in the core and the lower-melting component surrounds the core component to form a sheath. The core component can be formed of polypropylene and the sheath from polyethylene.

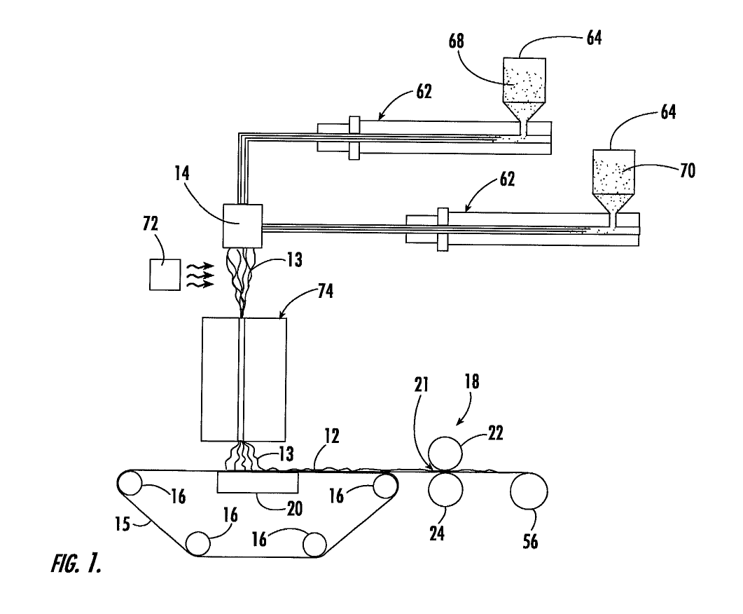

FIG. 1 shows part of an apparatus 10 for producing a thermally bonded nonwoven web 12 in accordance with one embodiment of the present invention, wherein the web is a spunbond nonwoven web. More particularly, in this embodiment the web 12 is formed of randomly arranged bicomponent filaments 13 that are prepared by a pair of extruders 62 that supply two different polymeric materials 68, 70 from hoppers 64 to a bicomponent spinneret 14. The two materials combine in the spinneret to form a sheath-core configuration. Spinnerets for producing bicomponent filaments are well known in the art and, therefore, are not described herein in detail. In one known embodiment, for example, the spinneret includes a housing about a spin pack, which includes a plurality of vertically stacked plates having a pattern of openings arranged to create flow paths for directing the two polymers separately to the fiber-forming openings in the spinneret. The fiber forming openings are arranged in one or more rows, and the openings form a downwardly extended curtain of filaments 13 when the polymers are extruded through the spinneret 14. As the filaments 13 exit the spinneret 14, they are contacted by a quenching gas 72, which is typically air, from one or both sides of the filament curtain, which at least partially quenches the filament. Typically, the quenching gas 72 will be directed generally perpendicularly to the length of the filaments 13 at a velocity of from about 30 to about 120 meters per minute and that a temperature of about 7° C. to about 32° C. In addition, a fiber draw unit or aspirator 74 can be positioned below the spinneret 14 for drawing and attenuating the filaments 13. The filaments are generally continuous and have diameters larger than about 7 microns and, more particularly, between about 10 and 30 microns.

The filaments 13 are deposited in a substantially random manner onto a moving carrier belt 15 that is driven over a set of rollers 16 by a conventional drive source (not shown) to form the web 12. Appropriate suction means 20 may be present under the carrier belt 15 away from the spinneret assembly 14 to assist depositing the filaments 13. It should be noted that while a single spinneret assembly and single layer filament web is shown, it is possible to provide additional spinning assemblies in-line to form a heavier web or a multi-layer web.

The advancing web 12 passes from the carrier belt 15 and is directed into and through a pressure nip 21 formed by calender rolls 18 comprising a heated embossing roll 22 and a hard-surfaced anvil roll 24. The embossing roll 22 is internally heated in a conventional manner, such as by circulation of a heat transfer fluid through the interior of the roll. The anvil roll 24 may also be heated in a similar manner. The time, temperature and pressure conditions at the calender nip are sufficient to heat the fibers or filaments to cause them to fuse and bond together, producing discrete fusion bond sites corresponding to the pattern of the embossing roll. The web 12 is directed past the calender rolls 18, such as to take-up roll 56.

In an alternative embodiment, not shown, the energy needed to produce fusion bonding of the fibers or filaments can be supplied from an ultrasonic source, such as an ultrasonic horn, mounted opposite the embossing roll 22 in lieu of the anvil roll 24.

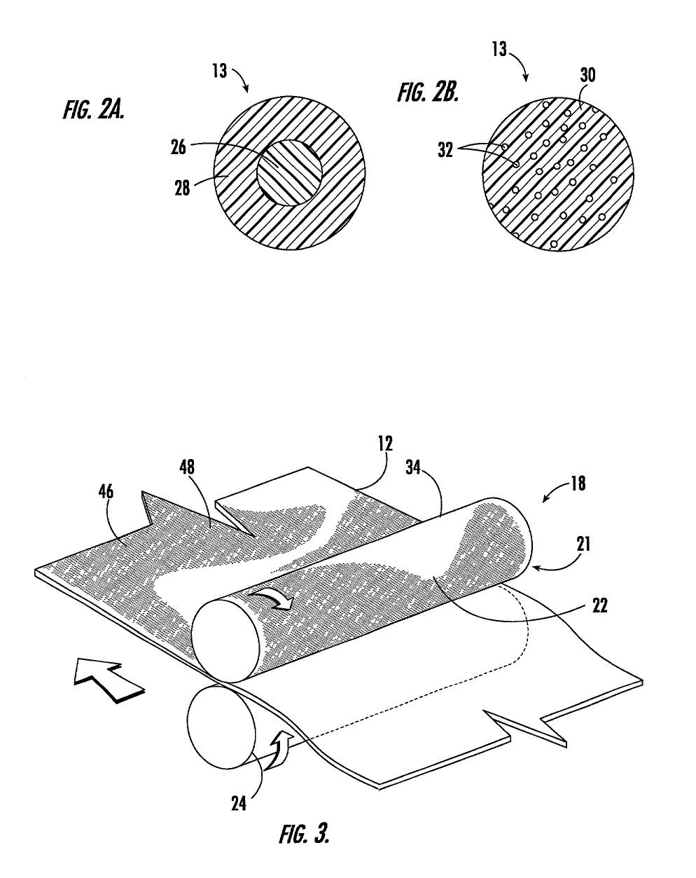

FIGS. 2A and 2B show two cross sectional examples of fibers according to the present invention. In particular, FIGS. 2A and 2B show fibers formed from at least two different polymers arranged as distinct phases in the cross section of the fiber. FIG. 2A shows a sheath-core bicomponent structure having a core 26 of a higher melting point polymer, such as polypropylene, and a sheath 28 of a lower melting point polymer, such as polyethylene. The properties of the core 26 and sheath 28 are advantageous to particular manufacturing processes, as discussed below. FIG. 2B shows a multiconstituent fiber formed from a highly dispersed blend of at least two different immiscible thermoplastic polymers in which a discontinuous phase 32 of a lower melting point polymer is dispersed in a dominant continuous polymer phase 30 of a higher melting point polymer. The discontinuous phase 32 occupies at least a portion of the fiber surface.

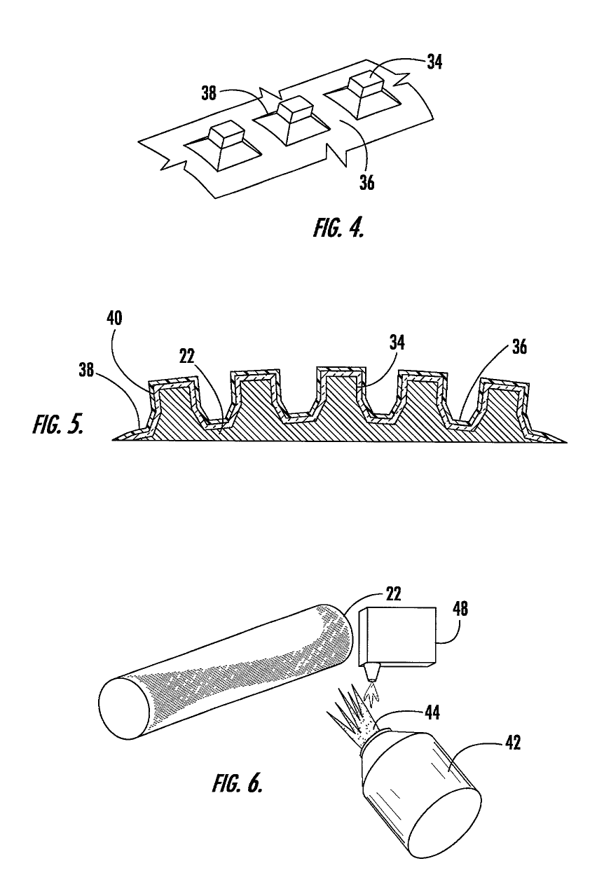

FIGS. 3 and 4 show views of the embossing roll 22 and anvil roll 24 according to one embodiment of the present invention. The embossing roll 22 is formed of metal and has an outer surface defining a multiplicity of raised calender lands 34. The lands 34 are spaced apart from one another by intervening depressions 36 so as to impart a repeating pattern on the web 12 as the web is directed through the nip 21. The lands form from about 4% to 40% of the surface area of the embossing roll 22. For hygiene applications, such as diaper topsheet, the lands preferably form a bond area of from about 10% to 30% at a density of about 100 to 300 lands per square inch. The embossing roll 22 may be produced from well known materials, such as steel, by engraving the outer surface of the roll to define the plurality of lands 34 according to a geometrically repeating pattern.

The embossing roll 22 has a hard, solid, non-sticking surface coating 38 of a fluoropolymer material permanently bonded to the roll surface. The coating should cover at least the depressions 36, but may suitably cover both the lands 34 and the intervening depressions 36. The surface coating 38 preferably comprises a fluoropolymer such as the polytetrafluoroethylene polymer sold under the trademark TEFLON™ and manufactured by Dupont. Other suitable fluoropolymers include hexafluoropropylene, monochlorotrifluoroethylene, or tetrafluoroethylene-hexafluoropropylene copolymer. Preferably, the coated embossing roll 22 has a Rockwell C hardness of 35 or greater, and most preferably 45 or greater. As is known in the art, the Rockwell C hardness test uses a diamond cone that is loaded against the surface of a material at 150 kg. and the depth of penetration of the cone is measured by testing machine and converted to a Rockwell hardness number. To attain the desired surface hardness, a hard tie coating 40 is preferably applied directly to the engraved roll surface, and the fluoropolymer surface coating 38 is applied to the tie coating 40. Examples of suitable hard tie coatings include ceramic compositions, carbides, molybdenum, nickel-chromium, stainless steel, and nickel. The tie coating 40 provides good adherence to the surface of the steel roll and is also adherent to the fluoropolymer surface coating 38.

FIG. 5 shows a cross sectional view of a portion of the embossing roll 22 having the outer surface thereof coated with the fluoropolymer surface coating 38 over the lands 34 and intervening depressions 36. In addition, FIG. 5 shows a hard tie coating 40 that is adhered to the surface of the roll 22 and interposed between the surface coating 38 and the roll whereby the surface coating is adhered to the tie coating. The tie coating 40, however, is not required, and the surface coating 38 can be adhered directly to the embossing roll 22. In either case, the surface coating 38 and tie coating 40 each have a thickness of no more than about 5 mils, for a total coating thickness of preferably no more than about 10 mils.

The tie coating 40 and the fluoropolymer surface coating 38 are most advantageously applied to the roll by a plasma spray coating process. FIG. 6 schematically illustrates a method of applying the surface coating 38 and/or tie coating 40 to the roll by plasma spray coating. In particular, the embossing roll 22 is subjected to a plasma coating process that includes directing a high temperature plasma stream 44 from a plasma torch 42 towards the surface of the embossing roll. The plasma stream 44 can reach temperatures of between 10,000 degrees and 50,000 degrees F. Powder of the surface coating 38 or tie coating 40 is injected from a supply 48 into the plasma stream 44, where it is rapidly heated and accelerated to a high velocity. The molten powder impacts on the surface of the embossing roll 22 and rapidly cools to form a coating. Advantageously, the plasma spray process is called a “cold process” because the temperature of the substrate, i.e., the embossing roll 22, can be kept low during processing, which protects the roll from damage, metallurgical changes, and distortion to the roll surface. Plasma torches are known in the art, such as plasma spray torches manufactured by ESAB Welding and Cutting Products of Florence, S.C.

The temperature of the nip 21 formed by the embossing roll 22 and anvil roll 24, as well as the nip pressure, should be selected and maintained so as to effectively bond the fibers forming the web 12 without causing deleterious side effects, such as excessive melting, which causes fuzzing and reduced life span of the web. The presence of the fluoropolymer surface coating on the roll makes it possible to operate the calender at a considerably higher temperature than would be possible with a bare metal engraved roll without causing undesirable calender stack wraps. In fact, the calender can be operated at a temperature well above the melting temperature of the lower-melting polymer component. As a result, the effective bonding window is significantly broadened. In a preferred embodiment using sheath-core bicomponent fibers which include a polypropylene core and a polyethylene sheath, the nip 21 is maintained at a temperature of from about 90-160 degrees C, and maintained at a pressure of about 50-1500 pounds per linear inch.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for bonding a nonwoven web comprising:
forming a nonwoven web of thermoplastic fibers or filaments containing a polymer which melts below 140° C.;
contacting the nonwoven web with a patterned embossing roll having an outer surface including a multiplicity of individual raised calender lands which are spaced apart from one another by intervening depressions, wherein at least said depressions are covered by a surface coating of a fluoropolymer; and
transferring energy to the nonwoven web to cause the fibers or filaments thereof to fuse and form point bond sites in discrete areas where the web is contacted by the raised calender lands.

2. A process according to claim 1, wherein the raised calender lands form from 4 to 40 percent of the surface area of the embossing roll.

3. A process according to claim 2, wherein the raised calender lands are present at a concentration of 40 to 500 lands per square inch.

4. A process according to claim 1, wherein the outer exposed surface of the embossing roll has a Rockwell C hardness of 35 or greater.

5. A process according to claim 1, wherein the step of contacting the nonwoven web with a patterned embossing roll comprises directing the nonwoven web through a calender nip formed between a smooth, hard-surfaced anvil roll and the patterned embossing roll.

6. A process according to claim 5, wherein the fluoropolymer surface coating is continuous over the surface of the patterned embossing roll and covers the raised lands and the intervening depressions.

7. A process according to claim 1, wherein the step of forming fibers or filaments into a nonwoven web comprises forming the fibers or filaments from at least two different polymers arranged as distinct phases in the cross-section of the fiber.

8. A process according to claim 7, wherein the fibers or filaments are formed as sheath-core structured bicomponent fibers or filaments having a sheath of a polymer which melts below 140° C. and a core of a polymer which melts at a higher temperature.

9. A process according to claim 7, wherein the fibers are formed from a highly dispersed blend of at least two different immiscible thermoplastic polymers which form a dominant continuous polymer phase of one melting point polymer in which is dispersed a discontinuous phase of a different melting point polymer.

10. A process for bonding a nonwoven web comprising:
forming a nonwoven web of thermoplastic fibers or filaments containing a polymer which melts below 140° C.;
contacting the nonwoven web with a patterned embossing roll having an outer surface including a multiplicity of individual raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of said roll and overlying at least said depressions, and a fluoropolymer surface coating adhered to said tie coating; and
transferring energy to the nonwoven web to cause the fibers or filaments thereof to fuse and form point bond sites in discrete areas where the web is contacted by the raised calender lands.

11. A process according to claim 10, wherein said hard tie coating and said fluoropolymer surface coating overlie both said lands and said depressions, and the outer exposed surface of the embossing roll has a Rockwell C hardness of 35 or greater

12. A process according to claim 10, wherein said tie coating and said fluoropolymer surface coating each have a thickness of no more than about 5 mils.

13. A process for bonding a nonwoven web comprising:
forming a nonwoven web of thermoplastic fibers or filaments containing a polymer which melts below 140° C.;
forming a calender nip between a smooth, hard-surfaced anvil roll and a cooperating patterned embossing roll, the patterned embossing roll including a metallic cylindrical roll core having an outer surface with a multiplicity of raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of said roll core and overlying at least said depressions, and a fluoropolymer surface coating adhered to said tie coating;
rotating the anvil roll and the embossing roll in opposite directions;
maintaining the calender nip at a temperature of from 90 to 160 degrees C. and at a pressure of 50 to 1500 pounds per linear inch; and
directing the nonwoven web through the calender nip and thermally bonding the thermoplastic fibers or filaments thereof in discrete areas corresponding to the raised calender lands.

14. A process according to claim 13, wherein said tie coating and said fluoropolymer surface coating each have a thickness of no more than about 5 mils.

15. A process according to claim 13, wherein the step of forming a nonwoven web comprises forming the fibers from at least two different polymers arranged as distinct phases in the cross-section of the fiber.

16. A process according to claim 15, wherein the fibers are formed as sheath-core structured bicomponent fibers having a sheath of said polymer which melts below 135° C. and a core of a higher melting point polymer.

17. A process according to claim 15, wherein the thermoplastic fibers comprise sheath-core structured bicomponent fibers having a polypropylene core and a polyethylene sheath.

18. A process according to claim 15, wherein the fibers are formed from a highly dispersed blend of at least two different immiscible thermoplastic polymers and have a dominant continuous polymer phase of a higher melting point polymer in which is dispersed a discontinuous phase of said polymer which melts below 135° C., and wherein said lower melting point discontinuous phase occupies a portion of the surfaces of the fibers.

19. A process for bonding a nonwoven web comprising:
forming a nonwoven web of sheath-core structured bicomponent fibers or filaments having a polypropylene core and a polyethylene sheath;
forming a calender nip between a smooth, hard-surfaced anvil roll and a cooperating patterned embossing roll, the patterned embossing roll having an outer surface including a multiplicity of raised calender lands which are spaced apart from one another by intervening depressions, wherein at least said depressions are covered by a surface coating of a fluoropolymer;
rotating the anvil roll and the embossing roll in opposite directions;
maintaining the calender nip at a temperature of at least 90 degrees C. and at a pressure of 50 to 1500 pounds per linear inch; and
directing the nonwoven web through the calender nip and thermally bonding the thermoplastic fibers or filaments thereof in discrete areas corresponding to the raised calender lands.

20. A process according to claim 19 wherein said step of forming a calender nip comprises forming the calender nip between said smooth, hard-surfaced anvil roll and a cooperating patterned embossing roll which includes a metallic cylindrical roll core having an outer surface with a multiplicity of raised calender lands and intervening depressions, a hard tie coating adhered to the surface of said roll core and overlying said lands and said depressions, and a fluoropolymer surface coating adhered to said tie coating and covering both said lands and said depressions.

21. An apparatus for producing a thermally bonded nonwoven web comprising:
means for forming a nonwoven web of thermoplastic fibers or filaments containing a polymer which melts below 135° C.;
a patterned embossing roll mounted for contacting the nonwoven web, said patterned embossing roll having an outer surface including a multiplicity of individual raised calender lands which are spaced apart from one another by intervening depressions, wherein at least said depressions are covered by a surface coating of a fluoropolymer; and
means cooperating with said roll for transferring energy to the nonwoven web to cause the fibers or filaments thereof to fuse and form point bond sites in discrete areas where the web is contacted by the raised calender lands.

22. Apparatus according to claim 21, wherein said means for transferring energy comprises means for internally heating said roll.

23. Apparatus according to claim 21, wherein said means for transferring energy comprises an ultrasonic horn cooperating with said patterned embossing roll.

24. Apparatus according to claim 21, wherein the raised calender lands form from 4 to 40 percent of the surface area of the embossing roll.

25. Apparatus according to claim 24, wherein the raised calender lands are present at a concentration of 40 to 500 lands per square inch.

26. Apparatus according to claim 21, wherein the outer exposed surface of the embossing roll has a Rockwell C hardness of 35 or greater.

27. An apparatus for producing a thermally bonded nonwoven web comprising:
means for forming a nonwoven web of thermoplastic fibers or filaments containing a polymer which melts below 135° C.;
a patterned embossing roll mounted for contacting the nonwoven web, said patterned embossing roll having an outer surface including a multiplicity of individual raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of said roll core and overlying at least said depressions, and a fluoropolymer surface coating adhered to said tie coating; and
means for transferring energy to the nonwoven web to cause the fibers or filaments thereof to fuse and form point bond sites in discrete areas where the web is contacted by the raised calender lands.

28. Apparatus according to claim 27 additionally including a smooth, hard-surfaced anvil roll cooperating with said a patterned embossing roll to form a calender nip, and wherein the fluoropolymer surface coating is continuous over the surface of the roll and covers the raised lands and the intervening depressions.

29. Apparatus according to claim 27, wherein said tie coating and said fluoropolymer surface coating each have a thickness of no more than about 5 mils.

30. Apparatus according to claim 27, wherein the outer exposed surface of the patterned embossing roll has a Rockwell C hardness of 35 or greater.

31. Apparatus according to claim 27, wherein the means for forming a nonwoven web includes means for forming the fibers from at least two different polymers arranged as distinct phases in the cross-section of the fiber.

32. Apparatus according to claim 27, wherein the surface coating of fluoropolymer is selected from the group consisting of polytetrafluoroethylene hexafluoropropylene, monochlorotrifluoroethylene, or tetrafluoroethylene-hexafluoropropylene copolymer and the outer surface of the roll has a Rockwell C hardness of at least 35.

33. An apparatus for producing a thermally bonded nonwoven web comprising:
means for forming a nonwoven web of thermoplastic fibers or filaments containing a polymer which melts below 135° C.;
a smooth, hard-surfaced anvil roll and a cooperating patterned embossing roll forming a calender nip, the patterned embossing roll including a metallic cylindrical roll core having an outer surface with a multiplicity of raised calender lands which are spaced apart from one another by intervening depressions, the raised calender lands being present at a concentration of 40 to 500 lands per square inch and forming from 4 to 40 percent of the surface area of the embossing roll, and the roll having a hard tie coating adhered to the surface of said roll core and overlying at least said depressions, and a fluoropolymer surface coating adhered to said tie coat;
means for rotating the anvil roll and the embossing roll in opposite directions;
means for maintaining the calender nip at a temperature of from 90 to 250 degrees C. and at a pressure of 50 to 1500 pounds per linear inch; and
means for directing the nonwoven web through the calender nip and thermally bonding the thermoplastic fibers or filaments thereof in discrete areas corresponding to the raised calender lands.

34. Apparatus according to claim 33, wherein said tie coating and said fluoropolymer each have a thickness of no more than about 5 mils.

35. Apparatus according to claim 34, wherein said hard tie coating and said fluoropolymer surface coating overlie both said lands and said depressions.

36. Apparatus according to claim 33, wherein said tie coating is a composition selected from the group consisting of ceramic compositions, carbides, molybdenum, nickel-chromium, stainless steel, and nickel.
